(19) United States
(12) Patent Application Publication
(10) Pub. No.: US 2012/0228803 A1
(43) Pub. Date: Sep. 13, 2012

(54) METHODS FOR FABRICATING HIGH TEMPERATURE CASTABLE ARTICLES AND GAS TURBINE ENGINE COMPONENTS

(75) Inventors: Jason Smoke, Phoenix, AZ (US); Wil Baker, Phoenix, AZ (US); Dennis Wolski, Chandler, AZ (US)

(73) Assignee: HONEYWELL INTERNATIONAL INC., Morristown, NJ (US)

(21) Appl. No.: 13/042,893

(22) Filed: Mar. 8, 2011

(51) Int. Cl. B29C 33/38; B29C 39/26; B29C 39/02; B29C 35/08; B29C 33/72

(52) U.S. Cl. 264/401; 264/39

(57) ABSTRACT

Embodiments of a method are provided for fabricating a high temperature castable article, such as a casting mold or a core. In one embodiment, the method includes the steps of providing a suspension containing a plurality of ceramic particles and a photo-curable monomer; photo-curing selected portions of the suspension to produce a green body coated, at least partially, with uncured suspension; and removing the uncured suspension from the green body under process conditions at which the viscosity of the uncured suspension is reduced. The process conditions include exposing the green body to one of the group consisting of: (i) microwave energy sufficient to excite a dipole moment of the uncured suspension and (ii) sonic energy sufficient to induce shear-thinning of the uncured suspension. The green body is then heat treated to produce the high temperature castable article.

### TECHNICAL FIELD

The present invention relates generally to rapid prototyping techniques and, more particularly, to embodiments of a method for fabricating castable articles wherein green body cleaning is performed under process conditions at which suspension viscosity is reduced.

### BACKGROUND

Turbine vanes, turbine blades, and other components employed within a gas turbine engine (“GTE”) and exposed to hot combustive gas flow during engine operation are typically cast from specialized high temperature superalloys. The casting molds and cores utilized to produce such hot section GTE components often have highly complex surface geometries. For example, a casting mold utilized to produce a single turbine vane may include a relatively intricate inner cavity, which defines the outer geometry of turbine vane, and a relatively complex inner core, which is positioned within the inner cavity to define cooling flow passages through the turbine vane. Casting molds and cores (collectively referred to herein as “castable articles”) have traditionally been cast utilizing conventional “hard” tooling, which is time consuming and costly to produce. While often justified in the context of large-scale production, such tooling costs can be prohibitively high for small-scale production runs and prototyping applications.

To provide a less costly alternative to conventional “hard” tooling, various types of rapid prototyping processes have been developed. In the aerospace industry, specifically, stereolithography (SLA) prototyping techniques are now utilized to produce high temperature casting molds and cores that can, in turn, be employed in the casting of hot section GTE components. Such castable articles are commonly formed from an SLA suspension or resin containing ceramic particles suspended within a ultraviolet-curable monomer liquid. During the SLA process, a laser is focused on selected areas of the SLA suspension to initiate polymerization and solidification of the monomer. This process is performed in an additive manner to gradually build, layer by layer, a green body comprised of a solid polymer impregnated with ceramic particle and submerged in a bath or pool of uncured suspension. The green body is removed from the bath, cleaned with solvent to clear away the uncured suspension, and then subjected to a series of heat treatment steps (e.g., drying, debinding, and firing) to decompose the polymer, sinter the ceramic particles, and produce the finished castable article. Due to its ceramic composition, the finished castable article is able to withstand extreme thermal exposure resulting from contact with the molten alloys during the subsequent casting of hot section GTE components.

The above-described SLA curing process produces a green body submerged within a pool of uncured suspension, which is in intimate contact with the green body and fills any cavities present in the green body. The uncured suspension is highly viscous and can be difficult to drain or otherwise clear away from a green body having complex inner geometries and/or relatively small internal dimensions. Furthermore, in instances wherein the green body contains tortuous or relatively small inner passageways, internal inspection of the green body to ensure complete drainage of the uncured suspension typically cannot be performed without destruction of the castable article. If not adequately cleared from the green body, the uncured suspension may solidify during the subsequently-performed debinding and firing processes to form irregularities in the castable article, such as occlusions obstructing the passages or ports of a casting mold. While washing or flushing with a solvent can facilitate the clearing away of uncured suspension, such solvent-based cleaning techniques are limited in their effectiveness; and, in instances wherein the green body has relatively thin-walled or otherwise fragile structural features, solvent cleaning generally cannot be performed at higher pressures.

It would thus be desirable to provide embodiments of a method for fabricating high temperature castable articles, such as casting molds and cores, enabling uncured suspension to be cleared away from a green body prior to firing in a complete and reliable manner. It would also be desirable to provide embodiments of a method wherein gas turbine engine components are fabricated utilizing such high temperature castable articles. Other desirable features and characteristics of the present invention will become apparent from the subsequent Detailed Description and the appended Claims, taken in conjunction with the accompanying Drawings and the foregoing Background.

### BRIEF SUMMARY

Embodiments of a method are provided for fabricating a high temperature castable article, such as a casting mold or a core. In one embodiment, the method includes the steps of providing a suspension containing a plurality of ceramic particles and a photo-curable monomer; photo-curing selected portions of the suspension to produce a green body coated, at least partially, with uncured suspension; and removing the uncured suspension from the green body under process conditions at which the viscosity of the uncured suspension is reduced. The process conditions include exposing the green body to one of the group consisting of: (i) microwave energy sufficient to excite a dipole moment of the uncured suspension and (ii) sonic energy sufficient to induce shear-thinning of the uncured suspension. The green body is then heat treated to produce the high temperature castable article.

In further embodiment, the method includes the step producing a casting utilizing, at least in part, a castable article fabricated from a green body cleaned under process conditions during which the green body was exposed to one of the group consisting of (i) microwave energy sufficient to excite a dipole moment of uncured suspension coating a portion of the green body, and (ii) sonic energy sufficient to induce shear-thinning of uncured suspension coating at least a portion of the green body.

### BRIEF DESCRIPTION OF THE DRAWINGS

At least one example of the present invention will hereinafter be described in conjunction with the following figures, wherein like numerals denote like elements, and:

FIG. 1 is a flowchart illustrating a method for fabricating a high temperature castable article wherein uncured suspension is removed from a green body under process conditions at which the viscosity of uncured suspension is lowered in accordance with an exemplary embodiment of the present invention.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

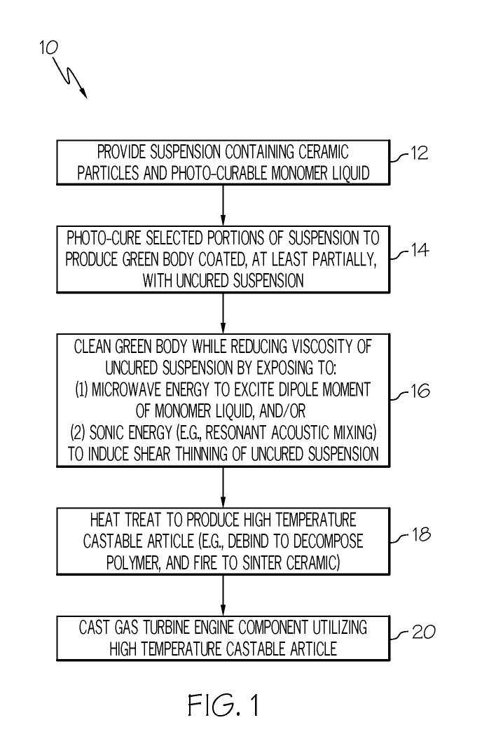

FIG. 1 is a flowchart illustrating a method 10 for fabricating a high temperature castable article including at least one cleaning step during which uncured suspension is removed from a green body under process conditions at which the viscosity of uncured suspension is lowered in accordance with an exemplary embodiment of the present invention. As appearing herein, the term “castable article” denotes a structural element or assemblage of structural elements utilized within a casting process to define at least one surface of a casting. Castable articles include, but are not limited to, casting molds and cores. In a similar regard, the term “high temperature castable article” is utilized herein to denote a castable article, as previously defined, suitable for usage in the casting of molten metals and alloys, including high temperature superalloys of the type described below from which hot section gas turbine engine components are commonly fabricated. The finished high temperature castable article preferably consists substantially entirely of ceramic, possibly in combination with other inorganic materials, and is consequently capable of withstanding exposure to temperatures well-exceeding temperature thresholds at which organic materials breakdown and decompose (approximately 260° C.).

To commence exemplary method 10 (STEP 12, FIG. 1), a photo-curable suspension is obtained or otherwise produced, which contains ceramic particles distributed within a photo-curable monomer liquid. The photo-curable monomer liquid may contain, in turn, a photo-curable monomer dissolved within a solvent, such as water, a water-detergent mixture, or a glycol-ether-based solvent (e.g., Tripropylene Glycol Methyl Ether or TPM). As appearing herein, the term “photo-curable monomer” refers to a monomer that undergoes polymerization when exposed to a particular type of electromagnetic radiation. In many cases, the photo-curable monomer will polymerize in response to exposure to ultraviolet light; however, photo-curable monomers that polymerize in response to electromagnetic radiation having shorter wavelengths and higher frequencies (e.g., X-ray energy) or electromagnetic radiation having longer wavelengths and lower frequencies (e.g., visible light or infrared radiation) may also be employed. As further appearing herein, the terms “photo-cure” and “photo-curing” each refer to the controlled polymerization of a photo-curable monomer as induced by exposure to a predetermined type of electromagnetic radiation. Finally, the term “ceramic particles” is utilized to denote particles or granules comprised of at least one inorganic and non-metallic material, whether crystalline or amorphous. Unless otherwise specified, the ceramic particles contained within the photo-curable suspension are not limited to any specific particle size range or shape.

Photo-curable suspensions of ceramic powders suitable for usage in the performance of exemplary method 10 are commercially available and often referred to as “high temperature stereolithography resins” or, more simply, “SLA resins.” Such high temperature, photo-curable suspensions should be distinguished from more common, low temperature SLA resins utilized to produce organic-based (e.g., plastic) prototyped components, which are generally incapable of withstanding direct exposure to the molten superalloys utilized in the casting of hot section gas turbine engine components, as described more fully below. As a non-limiting example, suitable high temperature SLA resins include WATERSHED® XC 11122 brand resins commercially available from DSM SOMOS®, an unincorporated subsidiary of DSM Desotech, Inc., headquartered in Elgin, Ill.

Next, at STEP 14 (FIG. 1), selected portions of the photo-curable suspension are cured to produce a green body in accordance with a previously-established three dimensional design, such as a virtual model produced utilizing Computer-Aided Design (CAD) software. Photo-curing of the suspension is preferably performed utilizing a photo-lithographic rapid prototyping process, such as stereolithography (also commonly referred to as “three dimensional printing,” “photo-solidification,” or “optical printing”). Stereolithography (“SLA”) processes are commonly carried-out utilizing an SLA machine including a suspension reservoir, which is filled with the uncured suspension; a platform, which can be gradually lowered into the suspension reservoir; and at least one laser, which is positioned above the suspension reservoir and which can be controlled to impinge upon surface regions of the uncured suspension held within the reservoir. The laser has a wavelength appropriate for inducing polymerization of the suspension's monomer; e.g., in embodiments wherein the monomer within the suspension is UV-curable, the SLA machine may include one or more UV lasers. To commence the SLA process, the UV laser is controlled to impinge upon selected regions of the exposed upper surface of the SLA suspension. The regions of the SLA suspension exposed to the laser polymerize and solidify to form an initial layer of the green body. The platform is then further lowered into the suspension-filled reservoir in a stepwise manner, and the uncured suspension flows over the recently-solidified green body layer. Selected regions of the exposed SLA suspension are again laser-cured to form an additional solidified layer, which overlays and cross-links to the underlying solidified layer. This additive process is repeated to gradually compile, layer by layer, a green body having the desired geometry and dimensions.

While the foregoing described an exemplary stereolithography process in conjunction with an exemplary SLA machine, it is emphasized that any suitable lithographical or photo-curing process can be employed during STEP 16 of exemplary method 10 (FIG. 1). Regardless of the particular photo-curing process employed, the green body produced pursuant to STEP 16 preferably has a composition consisting primarily of ceramic and including only so much polymer as required to impart the green body with sufficient structural integrity to withstand subsequent handling and heat treatment steps (e.g., the debinding process described below). Although the composition of the green body will inevitably vary amongst different embodiments of exemplary method 10 (FIG. 1), in one implementation, a green body is produced having a composition of approximately 70% ceramic and approximately 30% polymer, by volume.

Upon completion of the above-described curing process (STEP 14, FIG. 1), the green body is submerged within a bath or pool of uncured suspension. The uncured suspension thus envelopes and coats various surfaces of the green body and fills any internal features (e.g., cavities, internal flow passages, ports, etc.) present within the green body. The photo-curable suspension is typically highly viscous and can be difficult to remove from a green body having complex inner geometries or relatively small internal features. In embodiments wherein the green body is a casting mold, it can be particularly difficult to ensure full drainage of the uncured suspension from green bodies internal cavities, especially if the internal cavities are intricate or have relatively small dimensions. As previously noted, any uncured suspension that is not adequately cleared from the green body may solidify during subsequent debinding and firing processes to form irregularities in the castable article, such as occlusions obstructing the passages or ports of a casting mold. Such irregularities are generally unacceptable and may render the castable article useless for its intended purpose.

To ensure complete removal of uncured suspension from the green body, even when the green body is characterized by complex and/or small-scale internal geometries, exemplary method 10 further includes an enhanced green body cleaning process (STEP 16, FIG. 1). The enhanced cleaning process is performed under process conditions at which the viscosity of the uncured suspension, and specifically the viscosity of the monomer liquid, is decreased to promote the clearing away or drainage of uncured suspension from the newly-fabricated green body. In a preferred embodiment of exemplary method 10, these process conditions include one or both of the following: (i) exposure of the green body to microwave energy sufficient to temporarily excite the dipole moment of the monomer liquid and reduce the viscosity of the uncured suspension, and (ii) exposure of the green body to sonic energy sufficient to induce shear thinning of the uncured suspension and thereby reduce the viscosity of the uncured suspension. These process conditions are each discussed in detail below.

In certain embodiments, the green body is subjected to microwave energy during green body cleaning to excite the dipole moment of the monomer liquid and thereby decrease the viscosity of the uncured suspension. More specifically, the green body can be treated with microwave energy to excite the dipole moment of solvent (e.g., water) in which the photo-curable monomer is dissolved and/or the dipole moment of the monomer itself, providing that the monomer has a dipole moment. Notably, exposure of the green body, and the uncured suspension therein or thereon, to microwave energy has little effect on the green body itself; the green body contains little to no moisture and is composed primarily or entirely of a polymer, which lacks a dipole moment. If desired, a drying step can first be performed to further drive-out any solvent (e.g., water) that may be contained within the green body prior to exposure to microwave energy. Microwave treatment of the green body can be performed in a specialized microwave oven, possibly while the green body is rotated or otherwise moved within the oven. The particular process parameters (e.g., wavelength, direction, and duration) of the microwave energy employed within such a microwave-assisted or microwave-enhanced cleaning step can be tailored based upon the particular photo-curable monomer liquid employed and/or based upon green body geometry; however, the duration and intensity of microwave energy bombardment is preferably held within sufficient limits to ensure that structural damage does not result to the green body due any incidental heating of the photo-curable monomer liquid. In this manner, microwave treatment of the newly-fabricated green body is performed prior to firing and debinding of the green body and under process parameters that do not result in the sintering of the ceramic material within the green body. In certain embodiments, microwave treatment may be performed contemporaneously with solvent treatment, such as a solvent bath, wash, or flush. For example, in the case of a casting mold, solvent may be gently flushed through the green body's cavity or cavities while the green body is simultaneously bombarded with microwave energy to reduce the viscosity of any uncured suspension held therein.

In addition to or in lieu of bombardment with microwave energy, the uncured suspension may be exposed to sonic energy to decrease the viscosity of the uncured suspension and facilitate the removal thereof during green body cleaning (STEP 16, FIG. 1). More specifically, as the photo-curable suspension has a rheology susceptible to shear thinning, sufficient mechanical shear forces can be imparted to the uncured suspension via the application of sonic energy to reduce the viscosity of the uncured suspension and, specifically, the viscosity of the uncured monomer liquid. In a preferred embodiment embodiment, the green body is subjected to low frequency, high intensity acoustic utilizing a resonant acoustic mixing process during STEP 16 of exemplary method 10 (FIG. 1). In this case, the green body may first be loaded into a resonant acoustic mixer and secured to a fixture. The resonant acoustic mixture may then be activated, and the fixture may rapidly oscillate over a predetermined range of displacement (e.g., ±1 inch) at a predetermined frequency (e.g., 60 hertz) for a predetermined period of time. In this manner, a substantially uniform shear field may be generated across the green body and through the uncured suspension to reduce the viscosity of the uncured suspension and thereby promote the clearing away (e.g., drainage) of the uncured suspension from the green body. The frequency of the sonic energy applied to the green body during resonant acoustic mixing is preferably chosen to substantially correspond to the natural acoustic frequency of the uncured suspension and the green body, taken in conjunction with any other loads supported by the fixture of the resonant acoustic mixer (e.g., in the case of a casting mold, solvent poured into the green body's cavity or cavities) and the fixture itself (referred to herein as the “total supported load”). In one embodiment, the natural resonant frequency of the total supported load is determined by measuring the acceleration of the fixture utilizing an accelerometer over a range of frequencies to identify the frequency at which the fixture can be suitably oscillated with a minimal power input. The intensity of any sonic energy imparted to the green body during STEP 16 is preferably sufficiently limited to ensure that damage does not occur to any thin-walled or fragile structural features that may be included within the green body and to ensure that monomeric cross-linking or hardening of the uncured suspension does not occur. In certain embodiments, the application of sonic energy can be performed while the green body is submerged within a chemical bath or while an active solvent flow is directed over the outer surfaces of the green body.

As noted above, the viscosity of the uncured suspension can be reduced during STEP 16 (FIG. 1) by bombarding the green body with microwave energy, with acoustic energy, or with a combination thereof. In embodiments wherein both microwave energy and acoustic energy are employed, one or more microwave-enhanced cleaning steps may be performed in series with one or more acoustic-enhanced cleaning steps, with either the microwave-enhanced cleaning step or the acoustic-enhanced cleaning step performed first. The green body may also be treated with solvent during STEP 16 to further assist in the clearing away of uncured suspension from the green body. Such a solvent cleaning step can be performed in series with the microwave-assisted or acoustic-assisted cleansing steps in any desired order. Alternatively, as noted above, solvent treatment can be performed in concert with or simultaneously with microwave-assisted cleaning or acoustic-assisted cleaning, as a solvent bath, wash, or flush.

After cleaning the uncured suspension from the green body in the above-described manner (STEP 16, FIG. 1), a series of heat treatment steps is next performed to transform the green body into the finished castable article. As indicated in FIG. 1 at STEP 18, such heat treatment steps include a debinding step and a firing step. During debinding, the green body is subjected to elevated temperatures at which the cross-linked polymer decomposes, burns-away, and is effectively removed from the green body to leave a structure composed entirely or substantially entirely of ceramic. Firing is then performed to sinter, densify, and strengthen the ceramic and yield the finished castable article. One or more drying steps may also be performed during STEP 18, for example, prior to the debinding process to remove any excess moisture from the green body. Due to its non-organic, ceramic composition, the finished castable article is able to withstand exposure to the molten alloys utilized to cast the hot section gas turbine engine components without structural deformation or degradation.

To complete exemplary method 10 (FIG. 1, STEP 20), one or more gas turbine engine (“GTE”) components are cast utilizing the castable article produced pursuant to STEPS 12, 14, 16, and 18. In a preferred embodiment, the GTE components cast during STEP 20 are those components located within the combustor, turbine, and/or exhaust sections of the gas turbine engine and subject to direct exposure to combustive gas flow during engine operation. Such hot section GTE components may include, but are not limited to, turbine blades, vanes, shrouds, and combustor liner walls. Hot section components are typically cast from high temperature superalloys formulated to withstand the various failure modes (e.g., corrosion, oxidation, creep, etc.) associated with operation in a high temperature gas turbine engine environment. Nickel, nickel-iron, and cobalt-based superalloys are well-known within the aerospace industry and are readily commercially available. The castable article produced pursuant to the above-described method may assume the form of a casting mold, which defines the outer geometry of such a hot section GTE component. Additionally or alternatively, the castable article may assume the form of a core defining the inner geometry of such a hot section GTE component. If intended for installation or usage within a service-deployed gas turbine engine, the hot section GTE component may undergo further processing after casting including machining, further metallurgical processing, and/or the formation of one or more thermal barrier coatings, bond layers, and the like.

There has thus been described exemplary embodiments of a method for fabricating high temperature castable articles, such as casting molds and cores, wherein uncured suspension is cleared away from a green body under process conditions at which the viscosity of the uncured suspension is favorably reduced. As compared to conventional “hard” tooling, the above-described method can be utilized to produce castable articles in a highly cost effective and efficient manner. Although by no means limited to the production of such components, embodiments of the above-described method are especially well-suited for producing gas turbine engine components, such as turbine blades, vanes, and shrouds, whether for research purposes or for small-scale production purposes.

The foregoing has further provided a method for producing a casting or cast component, such as a hot section gas turbine engine component. In accordance with an embodiment of the method, the casting is produced utilizing, at least in part, a castable article fabricated from a green body cleaned under process conditions during which the green body was exposed to one of the group consisting of (i) microwave energy sufficient to excite the dipole moment of uncured suspension coating a portion of the green body, and (ii) sonic energy sufficient to induce shear-thinning of uncured suspension coating a portion of the green body.

While multiple exemplary embodiments have been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. A method for fabricating a high temperature castable article, comprising:
providing a suspension comprising a plurality of ceramic particles and a photo-curable monomer;
photo-curing selected portions of the suspension to produce a green body coated, at least partially, with uncured suspension;
removing the uncured suspension from the green body under process conditions at which the viscosity of the uncured suspension is reduced, the process conditions comprising exposing the green body to one of the group consisting of (i) microwave energy sufficient to excite a dipole moment of the uncured suspension and (ii) sonic energy sufficient to induce shear-thinning of the uncured suspension; and
heat treating the green body to produce the high temperature castable article.

2. A method according to claim 1 further comprising the step of casting a gas turbine engine component utilizing, at least in part, the high temperature castable article.

3. A method according to claim 1 wherein step of removing comprises treating the green body with a solvent.

4. A method according to claim 1 wherein the step of removing comprises exposing the green body to microwave energy sufficient to excite a dipole moment of the uncured suspension.

5. A method according to claim 1 wherein the step of removing comprises exposing the green body to sonic energy sufficient to induce shear-thinning of the uncured suspension.

6. A method according to claim 5 wherein the step of exposing green body to sonic energy comprises employing resonant acoustic mixing to induce shear thinning of the uncured suspension.

7. A method according to claim 1 wherein the high temperature castable article is selected from the group consisting of a casting mold and a core.

8. A method according to claim 7 wherein the castable article comprises a casting mold defining, at least in part, the outer geometry of a gas turbine engine component.

9. A method according to claim 7 wherein the castable article comprises a core defining, at least in part, the inner geometry of a gas turbine engine component.

11. A method according to claim 1 wherein the step of photo-curing comprises inducing polymerization of selected portion of the suspension utilizing a photo-lithographic rapid prototyping process.

12. A method according to claim 11 wherein the step of inducing polymerization comprises inducing polymerization of selected portion of the suspension utilizing a stereo-lithographic rapid prototyping process.

13. A method according to claim 1 wherein the step of photo-curing comprises inducing polymerization of selected portion of the suspension by exposure to ultraviolet radiation.

14. A method for fabricating a high temperature castable article, comprising:
providing a suspension comprising a plurality of ceramic particles and a photo-curable monomer;
photo-curing selected portions of the suspension to produce a green body having a cavity containing uncured suspension;
draining the uncured suspension from the cavity while exposing the green body to one of the group consisting of microwave energy and sonic energy to reduce the viscosity of the uncured suspension and promote the drainage thereof; and
heat treating the green body, after drainage of the uncured suspension therefrom, to decompose the polymerized portions of the green body, to sinter the ceramic portions of the green body, and to produce the high temperature castable article.

15. A method according to claim 14 wherein the step of draining comprising draining the uncured suspension from the cavity while exposing the green body to microwave energy.

16. A method according to claim 14 wherein the step of draining comprising draining the uncured suspension from the cavity while exposing the green body to sonic energy.

17. A method according to claim 16 wherein the step of exposing the green body to sonic energy comprises subject the green body to resonant acoustic mixing.

18. A method according to claim 14 further comprising the step of casting a gas turbine engine component utilizing, at least in part, the high temperature castable article.

19. A method comprising the step of:
producing a casting utilizing, at least in part, a castable article fabricated from a green body cleaned under process conditions during which the green body was exposed to one of the group consisting of (i) microwave energy sufficient to excite a dipole moment of uncured suspension coating a portion of the green body, and (ii) sonic energy sufficient to induce shear-thinning of uncured suspension coating a portion of the green body.

20. A method according to claim 19 wherein the casting comprises a gas turbine engine component.
